(19) United States
(12) Patent Application Publication
(10) Pub. No.: US 2008/0044003 A1
(43) Pub. Date: Feb. 21, 2008

(54) IN-EAR TYPE AND EAR-PLUG TYPE EARPHONE WITH ADJUSTABLE VOLUME OF REAR CHAMBER BETWEEN SPEAKER AND HOUSING

(75) Inventor: Bill Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COTRON CORPORATION, Taipei City (TW)

(21) Appl. No.: 11/530,030

(22) Filed: Sep. 8, 2006

(30) Foreign Application Priority Data
Jun. 29, 2006 (TW) 95123491

(51) Int. Cl. H04M 1/00; H04M 9/00

(52) U.S. Cl. 379/430

(57) ABSTRACT

An earphone with adjustable volume of a rear chamber between a speaker and a housing is provided, which includes a speaker unit, a housing and a movable element. The speaker is disposed within the housing, and the housing includes a chamber formed behind the speaker unit. The chamber has a volume, and the movable element is disposed on the housing and moves correspondingly with the chamber, so as to adjust the volume of the chamber. Therefore, the frequency response of the voice sent by the speaker unit is changed according to the of the volume of the chamber.

### CROSS-REFERENCE TO RELATED APPLICATION

This application claims the priority benefit of Taiwan application serial no. 95123491, filed Jun. 29, 2006. All disclosure of the Taiwan application is incorporated herein by reference.

### BACKGROUND OF THE INVENTION

1. Field of the Invention

The present invention relates to an earphone, and more particularly, to an earphone with adjustable volume of a rear chamber between a speaker and a housing.

2. Description of Related Art

With the rapid progress of the science and technology, the electronic product has gradually become light, chic and miniaturized, and people can use the miniaturized electronic products, such as radio or walkman, at anytime and anywhere. Moreover, the personal digital product, such as common MP3 walkmans, cell phones, personal digital assistants (PDAs) or notebooks, has increasingly become popular, and thus being indispensable in the daily life. In addition, the cell phone integrated with functions of both radio and MP3 has immerged.

No matter what kind of electronic products, the earphone has become an essential fitting for the electronic product, so the user can listen to the sound information provided by the electronic product without interfering others. Moreover, the earphone also provides a preferable sound transmission for the listener, such that he/she can hear and understand the content of the sound more clearly, unlike the circumstance that the sound is unclear when transmitting from computer speakers. Especially, when the user is moving, for example, when doing exercises, driving, conducting acute motions or in a noisy environment, since the earphone is used, the sound transmission will not be influenced.

However, since the size and structure of the ear and the ear canal are different from person to person, and a different person has a different favor for the music, thus, the judgment for the sound quality of the earphone varies as for different persons, and it is hard to meet the requirements of each person. Meanwhile, the frequency response curve of most earphones available in the market is fixed, and if the frequency response on high tone portion or low tone portion of the signal is to be changed, it requires changing the distribution characteristics of the sound field by an electronic equalizer or relevant software. Even though the additional electronic equalizer may change the frequency response of the earphone, the time delay caused by the inductance or capacitance within the electronic equalizer cannot be compensated. Therefore, it is an unavoidable task to improve the structure of the earphone.

### SUMMARY OF THE INVENTION

An objective of the present invention is to provide an earphone with adjustable volume of a rear chamber between a speaker and a housing, so as to change the sound field characteristic in the structure of the earphone body.

The present invention provides an earphone with adjustable volume of a rear chamber between a speaker and a housing, which comprises a speaker unit, a housing and a movable element. The speaker unit is disposed within the housing, and the housing includes a chamber formed behind the speaker unit. The chamber has a volume, and the movable element is disposed on the housing and moves correspondingly with the chamber, so as to adjust the volume of the chamber.

According to an embodiment of the present invention, the movable element comprises an inner sleeve, which is disposed within the chamber and suitable for extending out of the housing. Further, the housing correspondingly has a locking part for being locked with the outer surface of the inner sleeve.

According to an embodiment of the present invention, the movable element comprises an outer sleeve suitable for extending out of the housing. Furthermore, the housing correspondingly has a locking part for being locked with the inner surface of the outer sleeve.

The present invention employs a movable structure for adjusting the volume of the chamber, wherein the movable inner sleeve or outer sleeve is moved correspondingly with the chamber, so as to change the volume of the chamber. Therefore, each person may adjust the frequency response of the earphone body directing to different music, such that the earphone may meet different customers' requirements.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of an earphone with adjustable volume of a rear chamber of a speaker according to an embodiment of the present invention.

FIG. 2 is a frequency response curve diagram of the volume variation of the rear chamber on sound field characteristics of an earphone.

FIGS. 3 and 4 are schematic views of a movable element according to another two embodiments of the present invention respectively.

### DESCRIPTION OF EMBODIMENTS

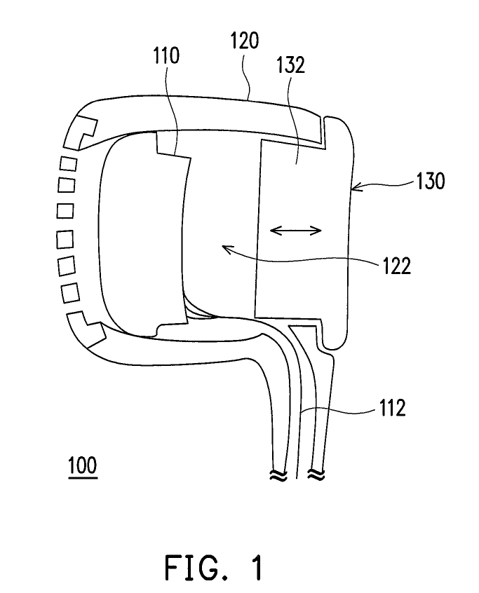

Referring to FIG. 1, it is a schematic cross-sectional view of an earphone with adjustable volume of a rear chamber between a speaker and a housing according to an embodiment of the present invention. A speaker unit 110 is disposed within the earphone housing 120, and is electrically connected to an external host (for example, MP3 player, cell phone, walkman or computer, etc.) via a transmission line 112, such that the speaker unit 110 can send out sound information that is acceptable for the human ear. The internal structure of the speaker unit 110 is not shown in FIG. 1. The profile size of the speaker unit 110 substantially matches with the volume of the internal chamber of the earphone housing 120, and the speaker unit 110 can be inserted into the cochlea of the human ear (not shown), thus, this type of earphone 100 is generally referred as an ear-plug type earphone or an in-ear type earphone. However, the earphone 100 with adjustable volume of the rear chamber behind the speaker according to the present invention may be widely applied in various types of earphones, but not limited to the ear-plug type earphone or the in-ear type earphone as shown in FIG. 1.

As shown in FIG. 1, the earphone housing 120 forms a chamber 122 behind the speaker unit 110 for generating a resonance effect, such that the sound field characteristics of the voice sent by the speaker unit 110 are different in the rear chamber 122. For example, the frequency response of high tone portion or low tone portion is changed, such that the high tone portion or the low tone portion is outstanding on the curve of the frequency response. Generally, when designing the sound field characteristic of the earphone, the actual volume of the rear chamber 122 is also taken into consideration to analyze the influence of the volume of the rear chamber 122 to the frequency response of high tone portion or low tone portion.

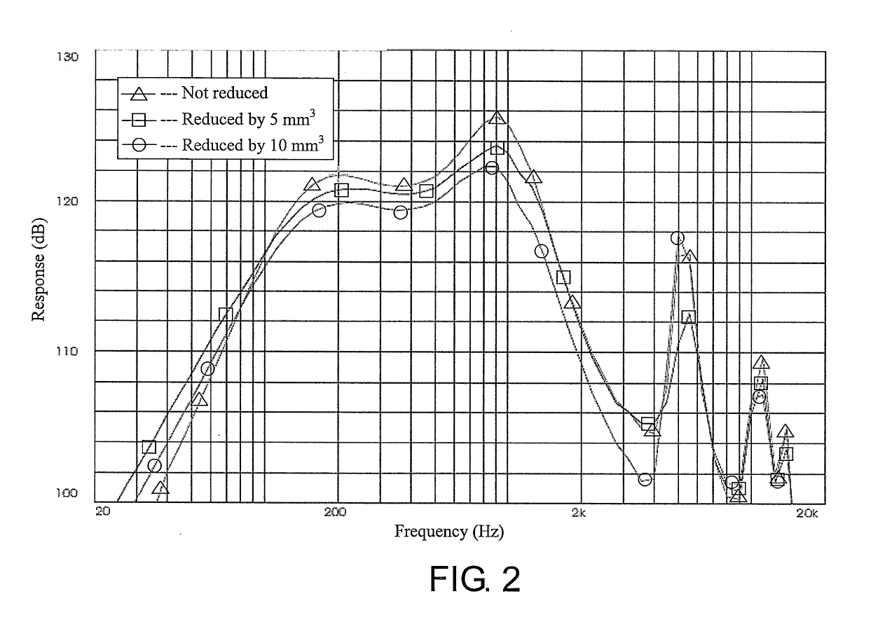

Referring to FIG. 2, it is a frequency-response curve diagram of the volume variation of the rear chamber on the sound field characteristic of an earphone. Difference frequency response curves are presented with different symbols. Within the audio frequency range that can be heard by human ear (20 Hz-20 KHz), it is known from the result of an artificial ear test that, the frequency response of a rear chamber with a smaller volume (e.g., reduced by 10 mm³ of the volume) to high frequency and intermediate frequency parts is less obvious, whereas the frequency response of a rear chamber with a larger volume (e.g., reduced by 5 mm³ of the volume) to low frequency part is more outstanding. Therefore, frequency response curve diagrams for rear chambers with different volumes are different. If the rear chamber 122 only has a fixed volume and cannot be adjusted as desired, the function of the rear chamber 122 is restricted, thus, the performance cannot be further improved.

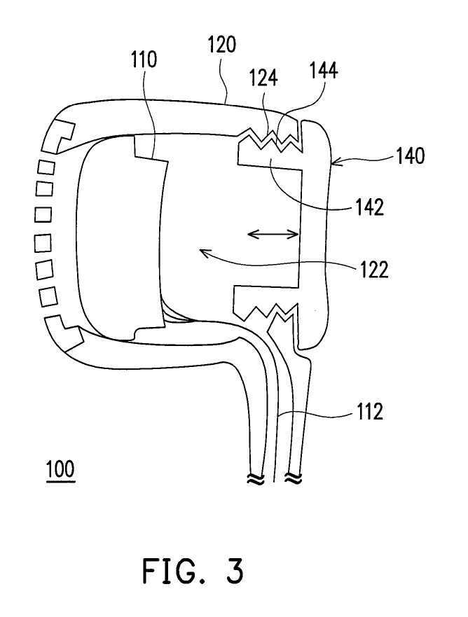

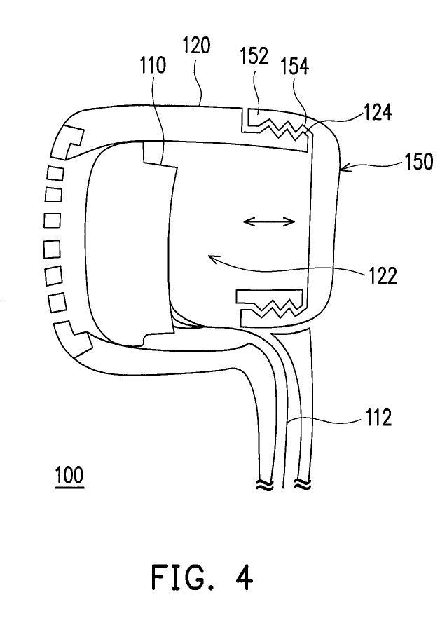

Therefore, the earphone 100 of the present invention employs a movable structure for adjusting the volume of the rear chamber between a speaker and a housing, which solves the above problem by moving the movable element 130 correspondingly with the rear chamber 122. As shown in FIG. 1, the movable element 130 comprises a column 132, which is disposed within the rear chamber 122 and can movably extend out of the housing 120, thereby increasing the volume of the rear chamber 122. FIGS. 3 and 4 are schematic views of the movable element according to another two embodiments of the present invention respectively.

As shown in FIG. 3, the movable element 140 comprises an inner sleeve 142 disposed within the rear chamber 122 for adjusting the volume of the rear chamber 122. In addition, the outer surface of the inner sleeve 142 further has a first locking part 144 (for example, a threaded part), and the inner wall of the earphone housing 120 correspondingly has a second locking part 124 (for example, a threaded part). The two locking parts are locked with each other, so that the inner sleeve 142 is screwed out with respect to the rear chamber 122, and extends out of the housing 120 along the axial direction, thereby increasing the volume of the rear chamber 122. In addition, when the inner sleeve 142 is screwed into the rear chamber 122, the volume of the rear chamber 122 is reduced.

Next, referring to FIG. 4, the movable element 150 comprises an outer sleeve 152 disposed outside the earphone housing 120 for adjusting the volume of the rear chamber 122. In addition, the inner surface of the outer sleeve 152 further has a first locking part 154 (for example, a threaded part), and the outer wall of the earphone housing 120 correspondingly has a second locking part 124 (for example, a threaded part). The two locking parts are locked with each other, so that the outer sleeve 152 is screwed out with respect to the rear chamber 122, and extends out of the housing 120 along the axial direction, thereby increasing the volume of the rear chamber 122. In addition, when the outer sleeve 152 is screwed into the rear chamber 122, the volume of the rear chamber 122 is reduced.

To sum up, the earphone with adjustable volume of a rear chamber between a speaker and a housing according to the present invention comprises a speaker unit, a housing and a movable element, wherein the movable element is disposed within the housing or outside the housing, and moves correspondingly with the chamber behind the speaker unit, so as to adjust the volume of the rear chamber, which no longer has only one fixed volume. The sound field characteristic of the sound emitted by the speaker unit in the rear chamber varies depending upon different volume of the rear chamber, thus, the present invention changes the sound field characteristic of the earphone by using a movable structure for adjusting the volume of the rear chamber between the speaker and the housing in terms of the structure of the earphone body. Therefore, each person can adjust the frequency response of the earphone body directing to different music, such that the earphone can meet different customers' requirements.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An earphone with adjustable volume of a rear chamber between a speaker and a housing, comprising:
a speaker unit;
a housing, covering the speaker unit and having a chamber formed behind the speaker unit, wherein the chamber has a volume; and
a movable element, disposed on the housing and moving correspondingly with the chamber, for adjusting the volume of the chamber.

2. The earphone with adjustable volume of a rear chamber between a speaker and a housing as claimed in claim 1, wherein the movable element comprises an inner sleeve, disposed within the chamber and suitable for extending out of the housing.

3. The earphone with adjustable volume of a rear chamber between a speaker and a housing as claimed in claim 2, wherein the housing correspondingly has a locking part, for being locked with the outer surface of the inner sleeve.

4. The earphone with adjustable volume of a rear chamber between a speaker and a housing as claimed in claim 1, wherein the movable element comprises an outer sleeve disposed outside the housing.

5. The earphone with adjustable volume of a rear chamber between a speaker and a housing as claimed in claim 4, wherein the housing correspondingly has a locking part, for being locked with the inner surface of the outer sleeve.

6. The earphone with adjustable volume of a rear chamber between a speaker and a housing as claimed in claim 1, wherein the movable element comprises a column, disposed within the chamber and suitable for extending out of the housing.

7. The earphone with adjustable volume of a rear chamber between a speaker and a housing as claimed in claim 1, wherein the size of the speaker unit is suitable for being inserted into an ear.
